(19) United States
(12) Patent Application Publication
(10) Pub. No.: US 2005/0289477 A1
(43) Pub. Date: Dec. 29, 2005

(54) Interface apparatus, systems, and methods

(76) Inventor: Kenn Christensen, Roskilde (DK)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/877,809

(22) Filed: Jun. 25, 2004

(51) Int. Cl. G06F 17/00

(52) U.S. Cl. 715/771

(57) ABSTRACT

Apparatus and systems, as well as methods and articles, may operate to power a human-computer interface device with a radio frequency field. A radio frequency identification tag may be used to transmit device position information.

### TECHNICAL FIELD

Various embodiments described herein relate to the fields of power, communications, and computer peripherals generally, including apparatus, systems, and methods for powering computer peripheral devices.

### BACKGROUND INFORMATION

Mice, keyboards, digitizers, and other human-computer interface devices may operate wirelessly, communicating over radio frequency links or infra-red links, for example, without cable attachment to a computer. These devices may be battery powered, sometimes adding undesirable size and weight. Utility and/or accuracy of the device may suffer as the batteries discharge, sometimes without warning. Device users may monitor the status of batteries and/or change batteries regularly to assure continued device operation.

### BRIEF DESCRIPTION OF THE DRAWINGS

FIG. 1 is a block diagram of an apparatus and a system according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

Various embodiments disclosed herein address powering a human-computer interface device without a connecting cable or batteries. In some embodiments, energy recovered from a radio-frequency field is used to power the device.

A “computer mouse” may include human-computer interface devices that detect operator body movement or other physical manifestations of operator intent, and convert the movement or other physical manifestations of operator intent to information usable by an application (e.g., a computer program).

A “mechanical change detector” may include a mode of detecting movement or a change in position through conversion of mechanical movement to machine-readable data.

An “optical change detector” may include a mode of detecting movement or a change in position through conversion of light reflection and/or absorption to machine-readable data.

“Radio-frequency identification” (RFID) may include techniques of wireless data collection employing radio frequency energy. For more information on RFID, see e.g. International Standards Organization (ISO) Standard 18000, “Information Technology—AIDC Techniques—RFID for Item Management—Air Interface” developed by Working Group 4 of Subcommittee 31 of ISO Joint Technical Committee 1 (ISO/IEC JTC 1/SC31), “Automatic Identification and Data Capture Techniques, Radio Frequency Identification.”

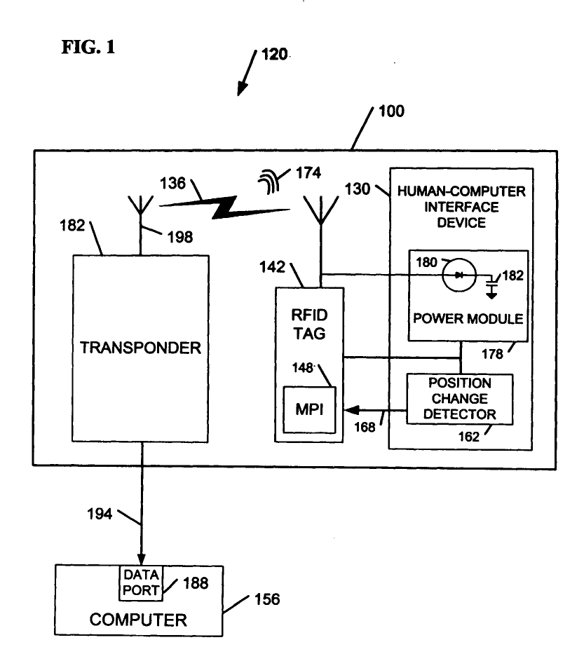

FIG. 1 is a block diagram of an apparatus 100 and a system 120 according to various embodiments of the invention. In some embodiments of the apparatus 100, a human-computer interface device 130 may be powered by a radio frequency field 136 communicating with a radio frequency identification tag 142. In some embodiments of the apparatus 100, the human-computer interface device 130 may include a computer mouse, a keyboard and/or a digitizer, among others.

In some embodiments of the apparatus 100, the radio frequency identification tag 142 may broadcast a set of modulated position information 148 associated with the human-computer interface device 130 to a computer 156. The radio frequency identification tag 142 may be attached to the human-computer interface device 130. In some embodiments of the apparatus 100, a position change detector 162 may provide a set of data 168 associated with the modulated position information 148.

In some embodiments of the apparatus 100, a radio frequency identification tag 142 may be powered by recovered radio frequency energy 174, and may communicate modulated position information (e.g., computer mouse position information 148) to a computer 156. In some embodiments, the apparatus 100 may include a power module 178 to store at least a portion of the recovered radio frequency energy 174. The power module 178 may include a rectifying element 180 and/or a storage element 182. In some embodiments, the power module 178 may provide power to the position change detector 162, which may include a mechanical change detector and/or an optical change detector. In some embodiments of the apparatus 100, the position change detector 162 may be capable of providing the data 168 associated with the computer mouse position information 148 directly. Other embodiments may be realized.

For example, a system 120 may include one or more of the apparatus 100 described previously. Some embodiments of the system 120 may include a human-computer interface device 130 to be powered by the radio frequency field 136 communicating with the radio frequency identification tag 142. Some embodiments of the system 120 may include a transponder 182 to receive the modulated position information 148 provided by the radio frequency identification tag 142. Some embodiments of the system 120 may include a computer 156 to couple to the transponder 182.

Some embodiments of the system 120 may include a data port 188 to receive a set of data 194 associated with the modulated position information 148. The data port 188 may include a computer mouse data port.

Some embodiments of the system 120 may include an antenna 198 to couple to the transponder 182. The antenna 198 may include one or more of a patch, omnidirectional, beam, monopole, dipole, and rhombic antenna, among others.

The apparatus 100, system 120, human-computer interface device 130, radio frequency field 136, radio frequency identification tag 142, modulated position information 148, computer 156, position change detector 162, data 168, recovered radio frequency energy 174, module 178, transponder 182, data port 188, data 194, and antenna 198 may all be characterized as “modules” herein. Such modules may include hardware circuitry, and/or a processor and/or memory circuits, software program modules and objects, and/or firmware, and combinations thereof, as desired by the architect of the apparatus 100 and system 120, and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, a signal transmission-reception simulation package, and/or a combination of software and hardware used to simulate the operation of various potential embodiments.

It should also be understood that the apparatus and systems of various embodiments can be used in applications other than for human-computer interface devices, and thus, various embodiments are not to be so limited. The illustrations of apparatus 100 and system 120 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others. Some embodiments include a number of methods.

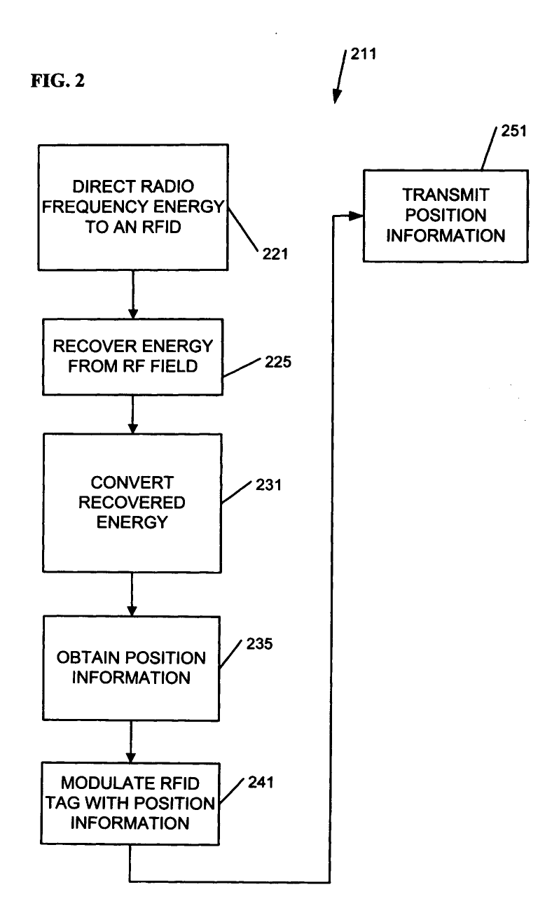

FIG. 2 is a flow diagram illustrating several methods 211 according to various embodiments. For example, a method 211 may (optionally) begin at block 221 with directing radio frequency energy (e.g., as part of a radio frequency field) to a radio frequency identification tag. In some embodiments, the method 211 may include recovering energy from a radio frequency field at block 225. Some embodiments of the method 211 may include converting energy recovered from a radio frequency field to power a human-computer interface device at block 231. The converted energy may be stored and/or used immediately, perhaps taking the form of a voltage or current, as desired. As noted previously, the human-computer interface device may comprise a digitizer, a computer mouse, and other devices. In some embodiments of method 211, the recovered energy of block 231 may comprise a sole source of power supplied to the human-computer interface device.

In some embodiments, the method 211 may include obtaining position information associated with the human-computer interface device at block 235. In some embodiments, the method 211 may include modulating position information associated with the human-computer interface device using a radio frequency identification tag attached to the human-computer interface device at block 241. In some embodiments, the method 211 may include transmitting the position information to a receiver using a portion of the recovered energy at block 251.

It should be noted that the methods described herein do not have to be executed in the order described, or in any particular order. Moreover, various activities described with respect to the methods identified herein can be executed in iterative, simultaneous, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

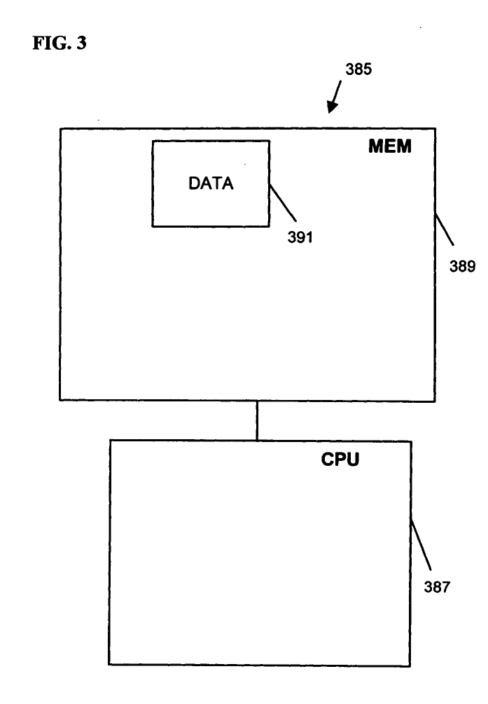

For example, FIG. 3 is a block diagram of an article 385 according to various embodiments, such as a computer, a memory system, a magnetic or optical disk, some other storage device, and/or any type of electronic device or system. The article 385 may include a processor 387 coupled to a machine-accessible medium such as a memory 389 (e.g., a memory including an electrical, optical, or electromagnetic conductor) having associated information 391 (e.g., computer program instructions and/or data), which, when accessed, results in a machine (e.g., the processor 387) performing such actions as directing radio frequency energy to a radio frequency identification tag. Other activities may include converting recovered energy from a radio frequency field to power a human-computer interface device. As noted previously, the converted energy may be stored and/or used immediately, perhaps taking the form of a voltage or current, as desired.

Some activities may include obtaining position information associated with the human-computer interface device. Other activities may include modulating position information associated with the human-computer interface device using a radio frequency identification tag attached to the human-computer interface device.

Implementing the apparatus, systems, and methods disclosed herein may enhance the reliability of wireless human-computer interface devices. In some embodiments, radio frequency identification tags may be used to transmit device position information.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An apparatus, including:
a human-computer interface device to be powered by a radio frequency field communicating with a radio frequency identification tag.

2. The apparatus of claim 1, wherein the human-computer interface device comprises a computer mouse.

3. The apparatus of claim 1, further including:
the radio frequency identification tag attached to the human-computer interface device.

4. The apparatus of claim 1, wherein the radio frequency identification tag is to broadcast modulated position information associated with the human-computer interface device to a computer.

5. The apparatus of claim 4, further including:
a position change detector to provide data associated with the modulated position information.

6. An apparatus, comprising:
a radio frequency identification tag to be powered by recovered radio frequency energy and to communicate computer mouse position information to a computer.

7. The apparatus of claim 6, further including:
a power module to store at least a portion of the recovered radio frequency energy and to power a position change detector.

8. The apparatus of claim 6, wherein the position change detector comprises one of a mechanical change detector and an optical change detector.

9. The apparatus of claim 8, wherein the position change detector is capable of providing data associated with the computer mouse position information.

10. A system, including:
a human-computer interface device to be powered by a radio frequency field communicating with a radio frequency identification tag; and
a transponder to receive modulated position information provided by the radio frequency identification tag.

11. The system of claim 10, further including:
a computer to couple to the transponder.

12. The system of claim 10, further including:
a data port to receive data associated with the modulated position information.

13. The system of claim 12, wherein the data port comprises a computer mouse data port.

14. The system of claim 10, further including:
an omnidirectional antenna to couple to the transponder.

15. A method, including:
converting recovered energy from a radio frequency field to power a human-computer interface device.

16. The method of claim 15, wherein the recovered energy comprises a sole source of power supplied to the human-computer interface device.

17. The method of claim 16, wherein the human-computer interface device comprises one of a digitizer and a computer mouse.

18. The method of claim 15, further including:
obtaining position information associated with the human-computer interface device; and
transmitting the position information to a receiver using a portion of the recovered energy.

19. An article comprising a machine-accessible medium having associated information, wherein the information, when accessed, results in a machine performing:
converting recovered energy from a radio frequency field to power a human-computer interface device.

20. The article of claim 19, wherein the information, when accessed, results in the machine performing:
modulating position information associated with the human-computer interface device using a radio frequency identification tag attached to the human-computer interface device.

21. The article of claim 19, wherein the radio frequency field comprises radio frequency energy directed to a radio frequency identification tag.

22. The article of claim 19, wherein the information, when accessed, results in the machine performing:
obtaining position information associated with the human-computer interface device.

23. The article of claim 19, wherein the human-computer interface device comprises one of a digitizer and a computer mouse.
